(19) United States
(12) Patent Application Publication
(10) Pub. No.: US 2006/0045240 A1
(43) Pub. Date: Mar. 2, 2006

(54) Method and apparatus for delayed answering of telecommunications request

(76) Inventor: Gregory C. Buchner, Los Altos, CA (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/217,798

(22) Filed: Aug. 31, 2005

Related U.S. Application Data
(60) Provisional application No. 60/606,408, filed on Aug. 31, 2004.

(51) Int. Cl. H04M 1/64

(52) U.S. Cl. 379/67.1

(57) ABSTRACT

Embodiments of the present invention are directed to a method and apparatus for delayed answering of a telecommunications request. In one embodiment of the present invention, a receiver of a telecommunications request initiates a delayed answer system. The delayed answering system indicates to the caller that the receiver intends to answer the call, but needs a few moments before doing so. In one embodiment, once the delayed answering system is activated, a message is relayed to the caller. In one embodiment, the message is a standard message. In another embodiment, the message is a personalized message. In yet another embodiment, the message is selected from a plurality of potential messages. In one embodiment, the message is selected based in full or in part upon the identification of the caller. In another embodiment, the receiver influences the selection of the message through the receiver's initiating keystrokes.

The present application claims the benefit of priority from pending U.S. Provisional Patent Application No. 60/606,408, entitled “Method and Apparatus for Delayed Answering”, filed on Aug. 31, 2004, which is herein incorporated by reference in its entirety.

### BACKGROUND OF THE INVENTION

1. Field of the Invention

The present invention relates to the field of telecommunications, and in particular to a method and apparatus for delayed answering of a telecommunications request.

2. Background Art

Prior art telecommunications systems provide a receiver of a request for communication with a variety of options. The receiver may accept the communication (e.g., by answering the telephone or cell phone), reject the communication (e.g., by not answering) or, if the system is so enabled, allow the communication to be passed to a proxy (e.g., an answering machine, answering service or voice mail). However, the decision of which option to use must be made by the receiver when the communication is requested, a time that is beyond the receiver's control and may be inconvenient. This problem can be better understood by a review of telecommunications systems.

Telecommunications Systems

Telecommunications systems enable one user (a caller) to attempt to initiate communication with another user. Both users must typically use a telecommunications device (e.g., a telephone, cell phone or computer with telephone software), and the receiver's device indicates (e.g., by ringing, vibrating or lighting up) that the caller desires to initiate communication. However, it is not always a convenient time for the receiver to deal with the request. For example, the receiver may be in the middle of a meeting, theater performance, important conversation or other similar activity.

Prior Art Receiving Options

In prior art systems, the call receiver must quickly decide how to handle the caller's request. The receiver can answer the call, allow an automated answering system (e.g., an answering machine, voice mail or answering service) to answer the call, allow the call to go unanswered or even quickly kill the request (e.g., by picking up and quickly setting down a telephone receiver without speaking into the receiver or by pressing the “end” button on a cell phone when voice mail is not enabled).

However, frequently, the receiver desires to accept the call, but is limited by his or her immediate situation. For example, the receiver may be in the middle of a business meeting where answering a cell phone would not be appropriate. In such a scenario, the receiver may attempt to leave the meeting room in time to answer the call, however it may be difficult to do so before the caller gives up or the automated answering system takes over. Thus, the receiver frequently answers and begins communication on the way out of the room, which is considered an ill-mannered disruption by many.

### SUMMARY OF THE INVENTION

Embodiments of the present invention are directed to a method and apparatus for delayed answering of a telecommunications request. In one embodiment of the present invention, a receiver of a telecommunications request initiates a delayed answer system. The delayed answering system indicates to the caller that the receiver intends to answer the call, but needs a few moments before doing so. In one embodiment, the receiver initiates the delayed answering system by pressing a single button. In another embodiment, the receiver initiated the delayed answering system by pressing a sequence of buttons.

In one embodiment, once the delayed answering system is activated, a message is relayed to the caller. In one embodiment, the message is a standard message. In another embodiment, the message is a personalized message. In yet another embodiment, the message is selected from a plurality of potential messages. In one embodiment, the message is selected based in full or in part upon the identification of the caller. In another embodiment, the receiver influences the selection of the message through the receiver's initiating keystrokes. Thus, a user can indicate an estimated time before the user will answer the call. In another embodiment, the message is a distinctive noise rather than a spoken communication.

In one embodiment, the message is stored on the receiver's telecommunications device. In another embodiment, the message is stored on the receiver's phone system (e.g., the receiver's cell phone provider's system or the receiver's telephone company's central office system). In yet another embodiment, the message is stored on the caller's telecommunications device. In still another embodiment, the message is stored on the caller's phone system.

In one embodiment, upon receiving the message, the caller may indicate his or her intention to attend something other than the telecommunications device while waiting for the caller to answer. Thus, when the receiver answers the call, another signal is sent to the caller to indicate the receiver is ready to communicate. Then, the caller's telecommunications device makes the caller aware of the receiver's readiness (e.g., by ringing, vibrating or flashing). In one embodiment, the receiver answers the delayed call by pressing one or more buttons. In another embodiment, the receiver answers the delayed call by speaking into the telecommunications device.

### BRIEF DESCRIPTION OF THE DRAWINGS

These and other features, aspects and advantages of the present invention will become better understood with regard to the following description, appended claims and accompanying drawings where:

FIG. 1 is a flow diagram of the process of delayed answering in accordance with one embodiment of the present invention.

FIG. 2 is a flow diagram of the process of selecting a standard delayed answer message in accordance with one embodiment of the present invention.

FIG. 3 is a flow diagram of the process of selecting a personalized delayed answer message in accordance with one embodiment of the present invention.

FIG. 4 is a flow diagram of the process of selecting a delayed answer message wherein a receiver influences selection of the message in accordance with one embodiment of the present invention.

FIG. 5 is a flow diagram of the process of delayed answering wherein the delayed answer message is stored on the receiver's telecommunications device in accordance with one embodiment of the present invention.

FIG. 6 is a flow diagram of the process of delayed answering wherein the delayed answer message is stored on the receiver's telecommunications system in accordance with one embodiment of the present invention.

FIG. 7 is a flow diagram of the process of delayed answering wherein the delayed answer message is stored on the caller's telecommunications system in accordance with one embodiment of the present invention.

FIG. 8 is a flow diagram of the process of delayed answering wherein the delayed answer message is stored on the caller's telecommunications device in accordance with one embodiment of the present invention.

FIG. 9 is a flow diagram of the process of caller inattention during a delayed answer in accordance with one embodiment of the present invention.

FIG. 10 is a flow diagram of the process of answering a telecommunications request in accordance with one embodiment of the present invention.

### DETAILED DESCRIPTION OF THE INVENTION

The invention is a method and apparatus for delayed answering of a telecommunications request. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Delayed Answering

In one embodiment of the present invention, a receiver of a telecommunications request initiates a delayed answer system. The delayed answering system indicates to the caller that the receiver intends to answer the call, but needs a few moments before doing so. Thus, the receiver can answer the call when the situation is more appropriate (e.g., when the receiver is completely out of the meeting room or theater hall, or when the receiver has completed another call).

In one embodiment, the receiver initiates the delayed answering system by pressing a single button. In another embodiment, the receiver initiated the delayed answering system by pressing a sequence of buttons. In one embodiment, delayed answering is incorporated with other answering/non-answering systems. Thus, when a call is received, the receiver has the option of answering immediately, allowing an automated answering system to handle the call, not answering or delayed answering.

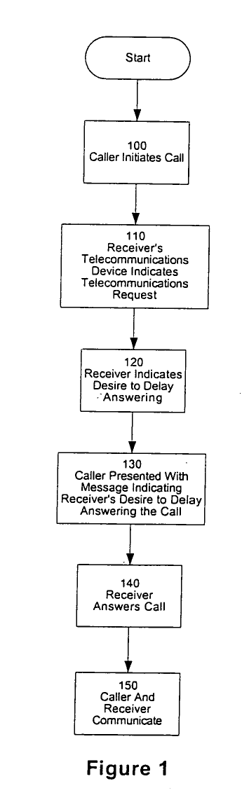

FIG. 1 illustrates the process of delayed answering in accordance with one embodiment of the present invention. At block 100, a caller initiates a call. At block 110, the receiver's telecommunications device indicates a telecommunications request. At block 120, the receiver indicates the desire to delay answering (e.g., by pressing a “delayed answer” button, another button or a sequence or other combination of buttons). At block 130, the caller is presented with a message indicating the receiver's desire to delay answering the call. At block 140, the receiver answers the call. At block 150, the caller and receiver communicate.

Standard Delayed Answer Messages

In one embodiment, once the delayed answering system is activated, a message is relayed to the caller. In one embodiment, the message is a standard message. In one embodiment, the standard message is a voice recording stating, “The caller you are attempting to reach will answer your call in a few moments. Please wait on the line.” In other embodiments, other standard messages are used to inform the caller of the receiver's intention to eventually answer the call.

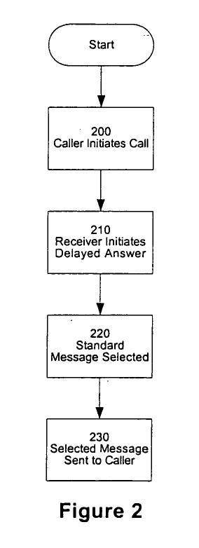

FIG. 2 illustrates the process of selecting a standard delayed answer message in accordance with one embodiment of the present invention. At block 200, a caller initiates a call. At block 210, the receiver initiates a delayed answer. At block 220, a standard message is selected, wherein the standard message informs the caller of the receiver's intention to eventually answer the call. At block 230, the selected message is sent to the caller.

Personalized Delayed Answer Messages

In another embodiment, the message is a personalized message. In yet another embodiment, the message is selected from a plurality of potential messages. In one embodiment, the message is selected based in full or in part upon the identification of the caller. For example, if a caller is calling from a number identified as belonging to a caller named Jose, a message, pre-recorded by the receiver, saying, “Jose, I'll answer your call. Just give me a few seconds,” is selected.

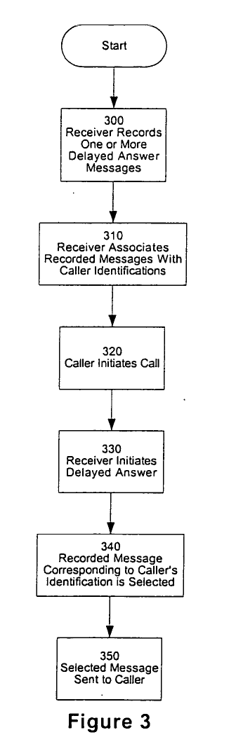

FIG. 3 illustrates the process of selecting a personalized delayed answer message in accordance with one embodiment of the present invention. At block 300, a receiver records one or more delayed answer messages. At block 310, the receiver associates the recorded messages with caller identifications. At block 320, a caller initiates a call. At block 330, the receiver initiates a delayed answer. At block 340, a recorded message corresponding to the caller's identification is selected. At block 350, the selected message is sent to the caller.

Delayed Answer Messages Selected or Generated From Receiver Input

In another embodiment, the receiver influences the selection of the message through the receiver's initiating keystrokes. Thus, a user can indicate an estimated time before the user will answer the call. In another embodiment, the message is a distinctive noise rather than a spoken communication.

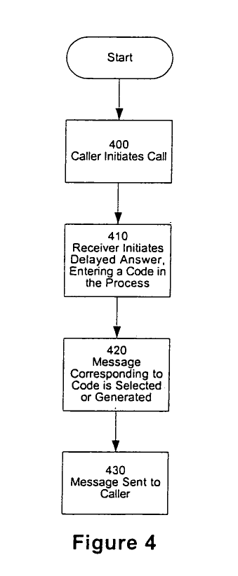

FIG. 4 illustrates the process of selecting a delayed answer message wherein a receiver influences selection of the message in accordance with one embodiment of the present invention. At block 400, a caller initiates a call. At block 410, the receiver initiates a delayed answer, entering a code in the process. In one embodiment, the receiver enters a code indicating the situation the receiver is in (e.g., driving and pulling over to answer, leaving a theater to answer, etc.). In another embodiment, the receiver enters a code indicating an estimated time (e.g., number of seconds or minutes) before the receiver will be able to answer.

At block 420, a message corresponding to the code is selected or generated. In one embodiment, message segments can be accumulated to form a message. For example, the segments “I will answer your call in”, “30”, and “seconds. Please wait,” are accumulated to form the message “I will answer your call in 30 seconds. Please wait.” At block 430, the message is sent to the caller.

Message Stored on Receiver's Telecommunications Device

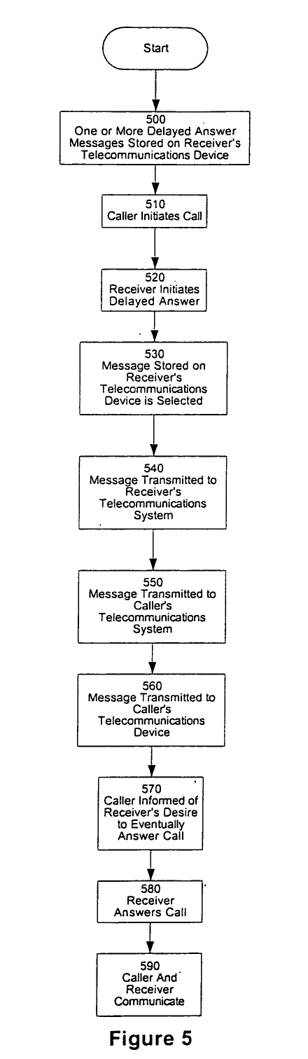

In one embodiment, the message is stored on the receiver's telecommunications device. FIG. 5 illustrates the process of delayed answering wherein the delayed answer message is stored on the receiver's telecommunications device in accordance with one embodiment of the present invention. At block 500, one or more delayed answer messages are stored on a receiver's telecommunications device. At block 510, a caller initiates a call. At block 520, the receiver initiates a delayed answer. At block 530, a message stored on the receiver's telecommunications device is selected.

At block 540, the message is transmitted to the receiver's telecommunications system. At block 550, the message is transmitted to the caller's telecommunications system. In various embodiments, the caller's and receiver's telecommunications systems are the same system, so blocks 540 and 550 are combined. At block 560, the message is transmitted to the caller's telecommunications device. At block 570, the caller is informed of the receiver's desire to eventually answer the call. At block 580, the receiver answers the call. At block 590, the caller and receiver communicate.

Message Stored on Receiver's Telecommunications System

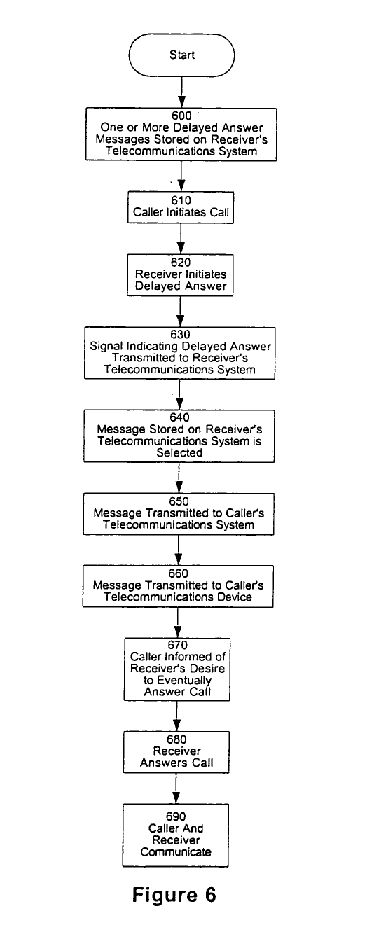

In another embodiment, the message is stored on the receiver's telecommunications system (e.g., the receiver's cell phone provider's system or the receiver's telephone company's system). FIG. 6 illustrates the process of delayed answering wherein the delayed answer message is stored on the receiver's telecommunications system in accordance with one embodiment of the present invention. At block 600, one or more delayed answer messages are stored on a receiver's telecommunications system. At block 610, a caller initiates a call. At block 620, the receiver initiates a delayed answer. At block 630, a signal indicating the delayed answer is transmitted to the receiver's telecommunications system. At block 640, a message stored on the receiver's telecommunications system is selected.

At block 650, the message is transmitted to the caller's telecommunications system. In various embodiments, the caller's and receiver's telecommunications systems are the same system, so 650 is redundant. At block 660, the message is transmitted to the caller's telecommunications device. At block 670, the caller is informed of the receiver's desire to eventually answer the call. At block 680, the receiver answers the call. At block 690, the caller and receiver communicate.

Message Stored on Caller's Telecommunications System

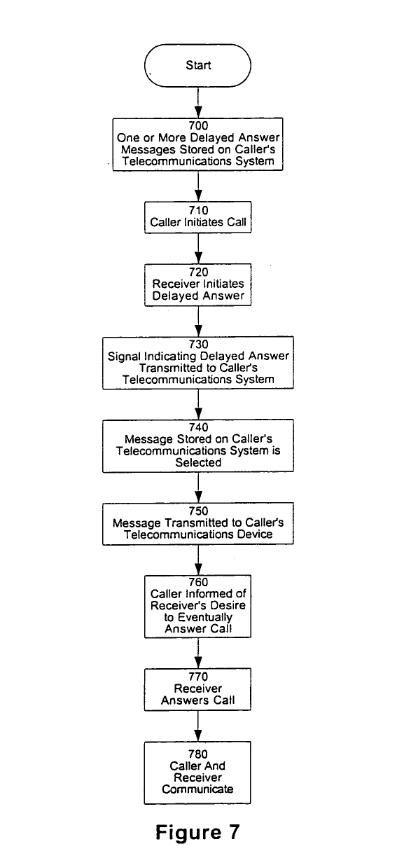

In still another embodiment, the message is stored on the caller's telecommunications system. FIG. 7 illustrates the process of delayed answering wherein the delayed answer message is stored on the caller's telecommunications system in accordance with one embodiment of the present invention. At block 700, one or more delayed answer messages are stored on a caller's telecommunications system. At block 710, the caller initiates a call. At block 720, a receiver initiates a delayed answer. At block 730, a signal indicating the delayed answer is transmitted to the caller's telecommunications system. At block 740, a message stored on the caller's telecommunications system is selected.

At block 750, the message is transmitted to the caller's telecommunications device. At block 760, the caller is informed of the receiver's desire to eventually answer the call. At block 770, the receiver answers the call. At block 780, the caller and receiver communicate.

Message Stored on Caller's Telecommunications Device

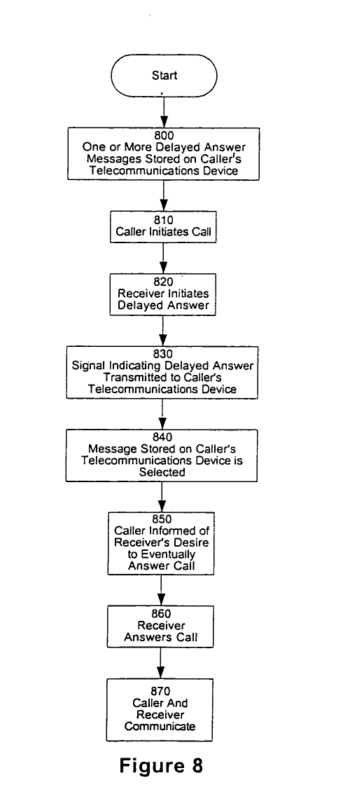

In yet another embodiment, the message is stored on the caller's telecommunications device. FIG. 8 illustrates the process of delayed answering wherein the delayed answer message is stored on the caller's telecommunications device in accordance with one embodiment of the present invention. At block 800, one or more delayed answer messages are stored on a caller's telecommunications device. At block 810, the caller initiates a call. At block 820, a receiver initiates a delayed answer.

At block 830, a signal indicating the delayed answer is transmitted to the caller's telecommunications device. At block 840, a message stored on the caller's telecommunications device is selected. At block 850, the caller is informed of the receiver's desire to eventually answer the call. At block 860, the receiver answers the call. At block 870, the caller and receiver communicate.

Caller Inattention During Delayed Answer

In one embodiment, upon receiving the message, the caller may indicate his or her intention to attend something other than the telecommunications device while waiting for the caller to answer. Thus, when the receiver answers the call, another signal is sent to the caller to indicate the receiver is ready to communicate. Then, the caller's telecommunications device makes the caller aware of the receiver's readiness (e.g., by ringing, vibrating or flashing).

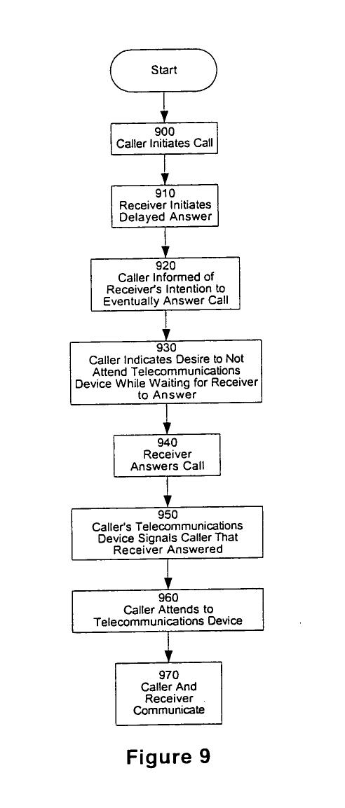

FIG. 9 illustrates the process of caller inattention during a delayed answer in accordance with one embodiment of the present invention. At block 900, a caller initiates a call. At block 910, the receiver initiates a delayed answer. At block 920, the caller is informed of the receiver's intention to eventually answer the call. At block 930, the caller indicates his or her desire to not attend the telecommunications device while waiting for the receiver to answer.

At block 940, the receiver answers the call. At block 950, the caller's telecommunications device signals the caller that the receiver has answered. At block 960, the caller attends to his or her telecommunications device. At block 970, the caller and receiver communicate.

Answering and Caller Impatience

In one embodiment, the receiver answers the delayed call by pressing one or more buttons. In another embodiment, the receiver answers the delayed call by speaking into the telecommunications device. In still another embodiment, the caller is presented with the option of either waiting or not. If the caller chooses not to wait, an automated answering system handles the call or, if there is not automated answering system, the call is ended. In yet another embodiment, the receiver's telecommunications device indicates whether the caller is waiting for the receiver to answer. Thus, if the caller did not wait for the delayed answer, the receiver need not answer the call.

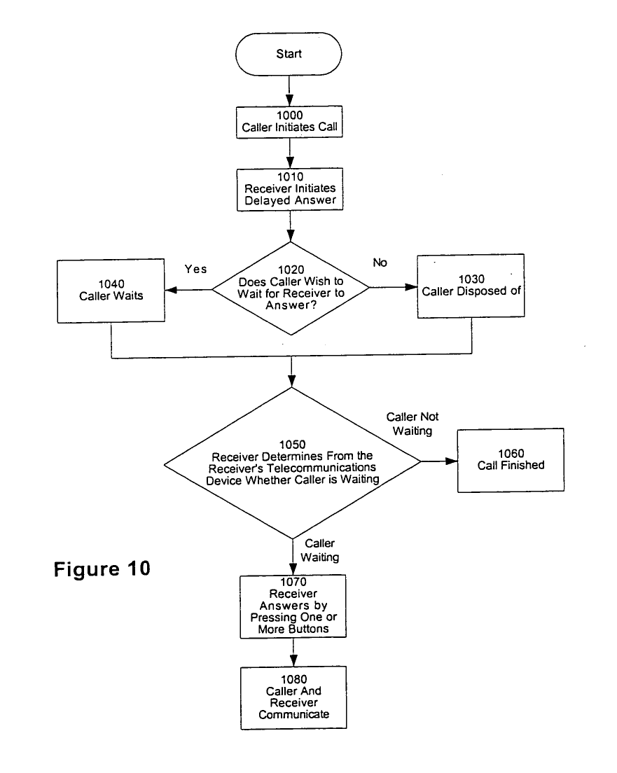

FIG. 10 illustrates the process of answering a telecommunications request in accordance with one embodiment of the present invention. At block 1000, a caller initiates a call. At block 1010, a receiver initiates a delayed answer. At block 1020, it is determined whether the caller wishes to wait for the receiver to answer. If the caller does not wish to wait for the receiver to answer, at block 1030, the caller is disposed of (e.g., by initiating an automated answering service or ending the call) and the process continues at block 1050.

If the caller wishes to wait for the receiver to wait, at block 1040, the caller waits. At block 1050, the receiver determines from the receiver's telecommunications device whether the caller is waiting. If the caller is not waiting, at block 1060, the call is finished. If the caller is waiting, at block 1070, the receiver answers by pressing one or more buttons. At block 1080, the caller and receiver communicate.

Thus, a method and apparatus for delayed answering of a telecommunications request is described in conjunction with one or more specific embodiments. The invention is defined by the following claims and their full scope and equivalents.

1. A method of answering a telecommunications request comprising:
sending said telecommunications request by a caller;
receiving said telecommunications request at a telecommunications device;
indicating a desire of a receiver to answer said request in the future;
communicating said desire to said caller; and
answering said telecommunications request in the future.

2. The method of claim 1 wherein said step of indicating comprises:
pressing a button by said receiver.

3. The method of claim 1 wherein said step of indicating comprises:
pressing a plurality of buttons.

4. The method of claim 1 wherein said step of communicating comprises:
sending a standard message to said caller.

5. The method of claim I wherein said step of communicating comprises:
sending a personalized message to said caller.

6. The method of claim 1 wherein said step of communicating comprises:
selecting a message from a plurality of messages wherein said message is selected based upon information associated with said caller; and
sending said message to said caller.

7. The method of claim 1 wherein said step of communicating comprises:
selecting a message from a plurality of messages wherein said message is selected based upon information entered by said receiver; and
sending said message to said caller.

8. The method of claim 1 wherein said step of communicating comprises:
generating a message; and
sending said message to said caller.

9. The method of claim 1 wherein said step of communication comprises:
storing a message on said telecommunications device.

10. The method of claim 1 wherein said step of communication comprises:
storing a message on a telecommunications system.

11. The method of claim 10 wherein said telecommunications system is associated with said receiver.

12. The method of claim 10 wherein said telecommunications system is associated with said caller.

13. The method of claim I wherein said step of communication comprises:
storing a message on a second telecommunications device wherein said second telecommunication device is associated with said caller.

14. The method of claim 1 further comprising:
indicating a desire not to attend while waiting by said caller after said step of communicating;
informing said caller of said step of answering; and
attending a call with said receiver by said caller after said step of informing.

15. A telecommunications request answering system comprising:
a request sender configured to send a telecommunications request by a caller;
a telecommunications device configured to receive said telecommunications request;
an indication system configured to indicate a desire of a receiver to answer said request in the future;
a communications unit configured to communicate said desire to said caller; and
an answering unit configured to answer said telecommunications request in the future.

16. The telecommunications request answering system of claim 15 wherein said indication system comprises:
a button wherein said button is pressed by said receiver.

17. The telecommunications request answering system of claim 15 wherein said indication system comprises:
a plurality of buttons wherein said plurality of buttons are pressed by said receiver.

18. The telecommunications request answering system of claim 15 wherein said communications unit comprises:
a message sending unit configured to send a standard message to said caller.

19. The telecommunications request answering system of claim 15 wherein said communications unit comprises:
a message sending unit configured to send a personalized message to said caller.

20. The telecommunications request answering system of claim 15 wherein said communications unit comprises:
a selection unit configured to select a message from a plurality of messages wherein said message is selected based upon information associated with said caller; and
a message sending unit configured to send said message to said caller.

21. The telecommunications request answering system of claim 15 wherein said communications unit comprises:
a selection unit configured to select a message from a plurality of messages wherein said message is selected based upon information entered by said receiver; and
a message sending unit configured to send said message to said caller.

22. The telecommunications request answering system of claim 15 wherein said communications unit comprises:
a message generator configured to generate a message; and
a message sending unit configured to send said message to said caller.

23. The telecommunications request answering system of claim 15 wherein said communications unit comprises:
a storage unit configured to store a message on said telecommunications device.

24. The telecommunications request answering system of claim 15 wherein said communications unit comprises:
a storage unit configured to store a message on a telecommunications system.

25. The telecommunications request answering system of claim 24 wherein said telecommunications system is associated with said receiver.

26. The telecommunications request answering system of claim 24 wherein said telecommunications system is associated with said caller.

27. The telecommunications request answering system of claim 15 wherein said communications unit comprises:
a storage unit configured to store a message on a second telecommunications device wherein said second telecommunication device is associated with said caller.

28. The telecommunications request answering system of claim 15 further comprising:
a second indication system configured to indicate a desire not to attend while waiting by said caller after said step of communicating;
an informing system configured to inform said caller of said step of answering; and
an attending system configured to attend a call with said receiver by said caller after said step of informing.

29. A computer program product comprising:
a computer usable medium having computer readable program code embodied therein configured to answer a telecommunications request, said computer program product comprising:
computer readable code configured to cause a computer to send said telecommunications request by a caller;
computer readable code configured to cause a computer to receive said telecommunications request;
computer readable code configured to cause a computer to indicate a desire of a receiver to answer said request in the future;
computer readable code configured to cause a computer to communicate said desire to said caller; and
computer readable code configured to cause a computer to answer said telecommunications request in the future.

30. The computer program product of claim 29 wherein said computer readable code configured to cause a computer to indicate comprises:
computer readable code configured to cause a computer to press a button.

31. The computer program product of claim 29 wherein said computer readable code configured to cause a computer to indicate comprises:
computer readable code configured to cause a computer to press a plurality of buttons.

32. The computer program product of claim 29 wherein said computer readable code configured to cause a computer to communicate comprises:
computer readable code configured to cause a computer to send a standard message to said caller.

33. The computer program product of claim 29 wherein said computer readable code configured to cause a computer to communicate comprises:
computer readable code configured to cause a computer to send a personalized message to said caller.

34. The computer program product of claim 29 wherein said computer readable code configured to cause a computer to communicate comprises:
computer readable code configured to cause a computer to select a message from a plurality of messages wherein said message is selected based upon information associated with said caller; and
computer readable code configured to cause a computer to send said message to said caller.

35. The computer program product of claim 29 wherein said computer readable code configured to cause a computer to communicate comprises:
computer readable code configured to cause a computer to select a message from a plurality of messages wherein said message is selected based upon information entered by said receiver; and
computer readable code configured to cause a computer to send said message to said caller.

36. The computer program product of claim 29 wherein said computer readable code configured to cause a computer to communicate comprises:
computer readable code configured to cause a computer to generate a message; and
computer readable code configured to cause a computer to send said message to said caller.

37. The computer program product of claim 29 wherein said computer readable code configured to cause a computer to communicate comprises:
computer readable code configured to cause a computer to store a message on said telecommunications device.

38. The computer program product of claim 29 wherein said computer readable code configured to cause a computer to communicate comprises:
computer readable code configured to cause a computer to store a message on a telecommunications system.

39. The computer program product of claim 38 wherein said telecommunications system is associated with said receiver.

40. The computer program product of claim 38 wherein said telecommunications system is associated with said caller.

41. The computer program product of claim 29 wherein said computer readable code configured to cause a computer to communicate comprises:
computer readable code configured to cause a computer to store a message on a second telecommunications device wherein said second telecommunication device is associated with said caller.

42. The computer program product of claim 29 further comprising:
computer readable code configured to cause a computer to indicate a desire not to attend while waiting by said caller after said step of communicating;
computer readable code configured to cause a computer to inform said caller of said step of answering; and
computer readable code configured to cause a computer to attend a call with said receiver by said caller after said step of informing.
